(19) United States
(12) Patent Application Publication
(10) Pub. No.: US 2017/0007921 A1
(43) Pub. Date: Jan. 12, 2017

(54) USER INTERFACE

(71) Applicant: COLOPL, INC., Tokyo (JP)

(72) Inventors: Naruatsu BABA, Tokyo (JP); Natsuo KASAI, Tokyo (JP); Daisuke FUKUDA, Tokyo (JP); Naoki TAGUCHI, Tokyo (JP); Iwao MURAMATSU, Tokyo (JP)

(21) Appl. No.: 15/276,692

(22) Filed: Sep. 26, 2016

Related U.S. Application Data
(63) Continuation of application No. PCT/JP2015/054783, filed on Feb. 20, 2015.

(30) Foreign Application Priority Data
Apr. 4, 2014 (JP) 2014-078244

(51) Int. Cl. A63F 13/2145; G06F 3/0488; G06F 3/0484; A63F 13/25; A63F 13/52

(52) U.S. Cl. CPC A63F 13/2145; A63F 13/25; A63F 13/52; G06F 3/04845; G06F 3/04883; G06F 3/04886

(57) ABSTRACT

A method includes detecting a first input indicative of a first position in an image output by a display, detecting a second input indicative of a second position in the image different from the first position, and causing an object to be output by the display based on the first input or the second input. The object includes a boundary having a first end closer to the first position than to the second position, and a second end closer to the second position than to the first position.

### RELATED APPLICATIONS

The present application is a continuation of International Application Number PCT/JP2015/054783, filed Feb. 20, 2015, which claims priority from Japanese Application Number 2014-078244, filed Apr. 4, 2014, the disclosures of which application are hereby incorporated by reference herein in their entirety.

### BACKGROUND

Users sometimes interact with software by way of a user interface including a virtual joystick or other type of virtual controller. Virtual controllers are often visible to a user via the user interface. Virtual controllers sometimes limit a user's experience with the software, because some virtual controllers provide limited feedback to a user, while other virtual controllers are visually distracting to the user.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of an example of a user interface.

FIG. 2 is an illustration of an example of another user interface.

FIG. 3 is a schematic diagram of a mobile terminal for executing a user interface, in accordance with some embodiments.

FIG. 4 is a block diagram for schematically illustrating a configuration of the mobile terminal of FIG. 3, in accordance with some embodiments.

FIG. 5 is a block diagram for illustrating an outline of input/output conducted in the mobile terminal of FIG. 3, in accordance with some embodiments.

FIG. 6 is a schematic diagram of a user interface displayed in a contact start point of a slide operation, in accordance with some embodiments.

FIG. 7 is a schematic diagram of a user interface displayed in a contact end point of the slide operation, in accordance with some embodiments.

FIG. 8 is a schematic diagram of a user interface displayed after the slide operation is finished, in accordance with some embodiments.

FIG. 9 is a diagram of functional blocks implemented by using the user interface, in accordance with some embodiments.

FIGS. 10(a) and 10(b) are illustrations of a user interface image of an elastic object displayed in the contact start point of the slide operation, in accordance with some embodiments.

FIG. 11 is a schematic diagram of a polygon that forms a part of the elastic object of FIGS. 10(a) and 10(b), in accordance with some embodiments.

FIG. 12 is a schematic diagram for illustrating a change of the polygon exhibited when a part of the elastic object of FIG. 11 is elastically deformed, in accordance with some embodiments.

FIG. 13 is a schematic diagram relating to elastic object deformation processing according to Example 1 of the present disclosure, in accordance with some embodiments.

FIG. 14 is a schematic diagram relating to polygon direction adjustment processing to be conducted when the elastic object is deformed, in accordance with some embodiments.

FIGS. 15(a)-15(c) are schematic diagrams for illustrating the elastic object deformation processing according to Example 1 with a lapse of time, in accordance with some embodiments.

FIGS. 16(a) and 16(b) are schematic diagrams for illustrating a case where another slide operation is conducted in regard to the elastic object deformation processing according to Example 1, in accordance with some embodiments.

FIG. 17 is a schematic diagram relating to elastic object deformation processing according to Example 2, in accordance with some embodiments.

FIG. 18 is an overall processing flowchart relating to the elastic object deformation processing, in accordance with some embodiments.

FIG. 19 is a detailed processing flowchart relating to the elastic object deformation processing according to Example 2, in accordance with some embodiments.

FIGS. 20(a)-20(c) are schematic diagrams relating to elastic object deformation processing according to Example 3, in accordance with some embodiments.

FIG. 21 is a detailed processing flowchart relating to the elastic object deformation processing according to Example 3, in accordance with some embodiments.

FIGS. 22(a) and 22(b) are schematic diagrams for illustrating the elastic object deformation processing according to Example 3 with a lapse of time, in accordance with some embodiments.

FIG. 23 is a schematic diagram relating to elastic object deformation processing according to Example 4, in accordance with some embodiments.

FIG. 24 is a screen diagram for illustrating a game application example of the user interface conducted according to Example 1 or Example 2, in accordance with some embodiments.

FIG. 25 is a screen diagram for illustrating a game application example of the user interface conducted according to Example 1 or Example 2, in accordance with some embodiments.

FIG. 26 is a screen diagram for illustrating a game application example of the user interface conducted according to Example 1 or Example 2, in accordance with some embodiments.

FIG. 27 is a screen diagram for illustrating a game application example of a user interface conducted according to Example 4, in accordance with some embodiments.

FIG. 28 is a schematic diagram for illustrating another game application example of a user interface formed by executing the user interface, in accordance with some embodiments.

FIG. 29 is a schematic diagram for illustrating deformation of an elastic object illustrated in FIG. 28, in accordance with some embodiments.

FIG. 30 is a schematic diagram relating to run-up movement processing based on the user interface illustrated in FIG. 28, in accordance with some embodiments.

FIG. 31 is a diagram for illustrating a processing flowchart relating to the run-up movement processing based on the user interface illustrated in FIG. 28, in accordance with some embodiments.

FIG. 32 is a screen diagram for illustrating a game application example of the user interface corresponding to FIG. 30, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Some user interfaces are configured to display an operation button (e.g., a cross button, joystick, or the like) on a touch panel of a smartphone. A user can interact with software via the user interface. For example, some user interfaces facilitate a user's ability to control a game character to move or perform some action through use of the operation button. Some user interfaces are configured to display, based on a drag process, a cursor that extends from a start point of dragging to an end point thereof and differs in size or shape between one end portion on a start point side and another end portion on an end point side.

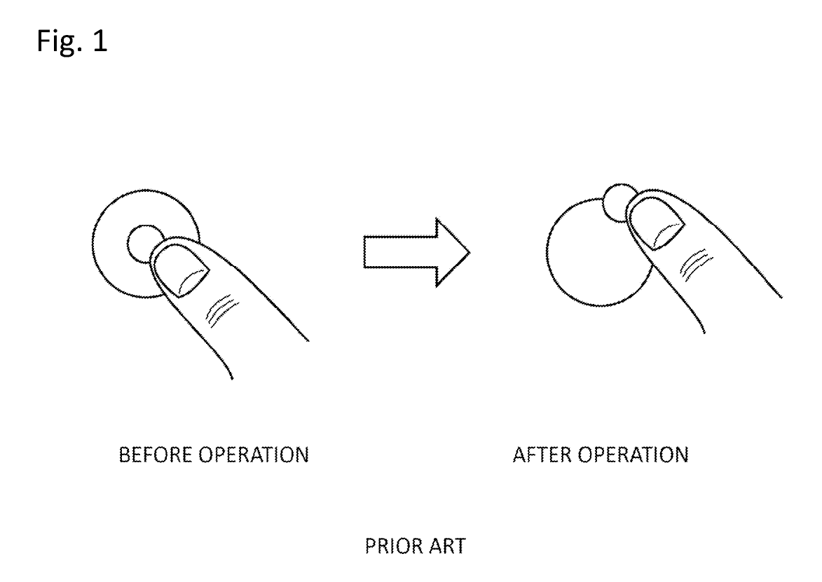

FIG. 1 illustrates a user interface comprising a virtual joystick. The user interface illustrated in FIG. 1 is displayed by arranging two circles that are large and small in the shape of concentric circles, and is configured so that, when a slide operation is conducted by the user, the small circle is displaced toward a direction of the slide operation. This allows the user to recognize a moving direction of the game character.

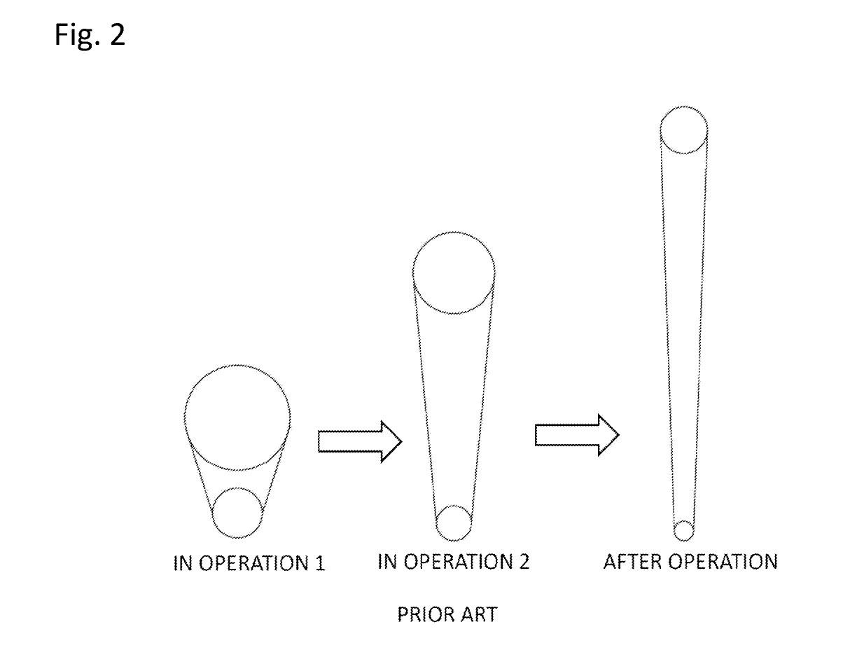

FIG. 2 illustrates a user interface comprising a cursor. The user interface illustrated in FIG. 2 is displayed by arranging two circles that are large and small in one end portion on the start point side and another end portion on the end point side, and forms one cursor by connecting the two circles to each other with lines. The cursor is formed so as to have a narrower area as the cursor becomes longer in order to maintain the area of the cursor at a fixed level. A user can conduct a drag operation while recognizing information including positions of the start point and the end point of the drag operation, a distance from the start point to the end point, and a direction from the start point to the end point. The cursor is formed by connecting the two circles that are large and small.

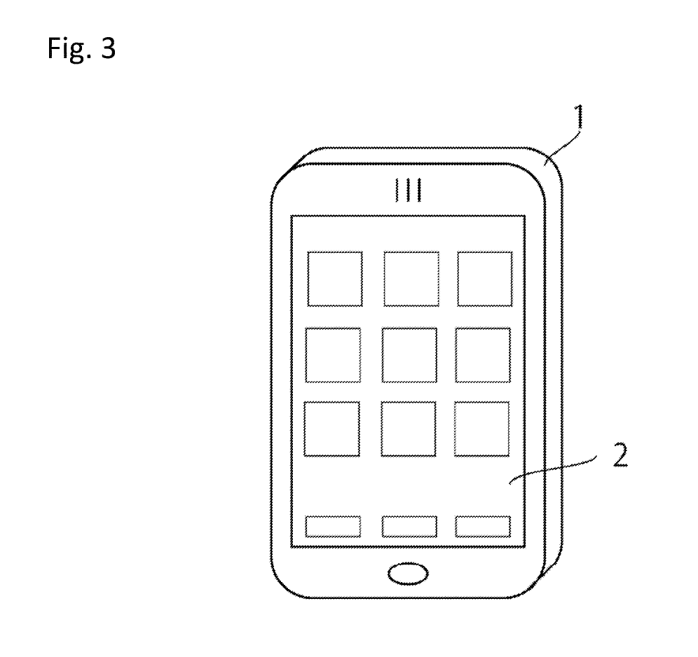

Now, with reference to FIG. 3 and the subsequent figures, a description is made of a user interface for controlling an action of a character within a virtual space and for causing the action of the character to be displayed based on an operation conducted via the user interface through the use of a deformable elastic object, in accordance with some embodiments.

In some embodiments, the virtual space is associated with software with which a user is able to interact by way of the user interface. In some embodiments, the software is associated with a game program, and the user interface is usable to control an action of a game character or game object within the virtual space as a part of the game program.

FIG. 3 is a perspective view of an apparatus by which an embodiment is implemented. In FIG. 3, a smartphone 1 includes a touch panel 2, and the user can control the action of the game character through a user operation conducted on the touch panel 2. Note that, the mobile terminal to execute the user interface according to this embodiment is not limited to the smartphone 1, and any device may be employed that is capable of receiving an input from a user and capable of causing an image to be output by a display based on the input from the user. In some embodiments, the device is a processor, a computer, a mobile device, a PDA, a tablet computer.

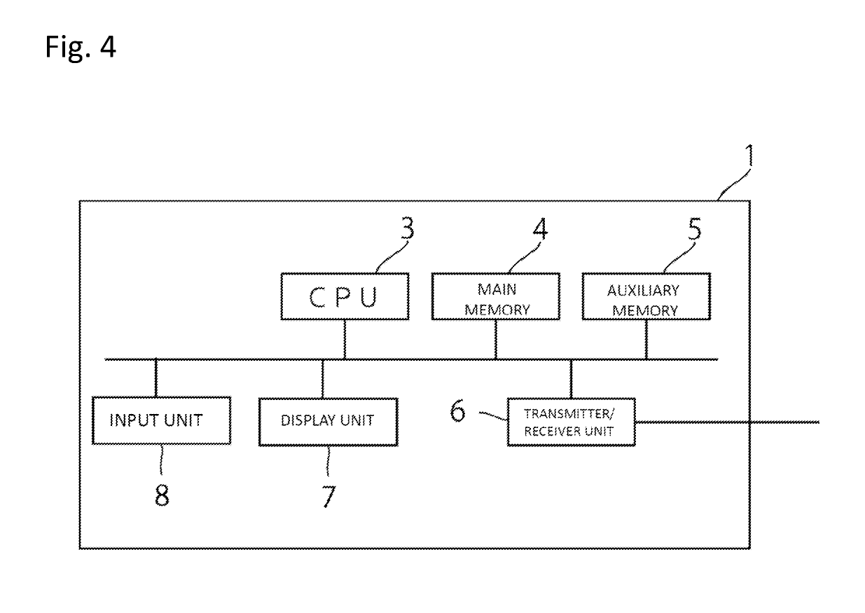

FIG. 4 is a block diagram of the smartphone 1, in accordance with some embodiments. The smart phone 1 includes a CPU 3, a main memory 4, an auxiliary memory 5, a transmitter/receiver unit 6, a display unit 7, and an input unit 8, which are connected to one another through a bus. Of those, the main memory 4 is formed of, for example, a DRAM, and the auxiliary memory 5 is formed of, for example, an HDD. The auxiliary memory 5 is a recording medium capable of recording the user interface and the game program according to this embodiment. The user interface stored in the auxiliary memory 5 is expanded onto the main memory 4, and executed by the CPU 3. Note that, data generated while the CPU 3 has been operating in accordance with the user interface and the game program and data to be used by the CPU 3 are also temporarily stored on the main memory 4. Under control of the CPU 3, the transmitter/receiver unit 6 establishes a connection (wireless connection and/or wired connection) between the smartphone 1 and a network, and transmits and receives various kinds of information. The display unit 7 displays various kinds of information to be presented to the user under control of the CPU. The input unit 8 detects an input operation (mainly, operation involving physical contact such as touch operation, slide (swipe) operation, and tap operation) conducted with respect to the touch panel 2 by the user.

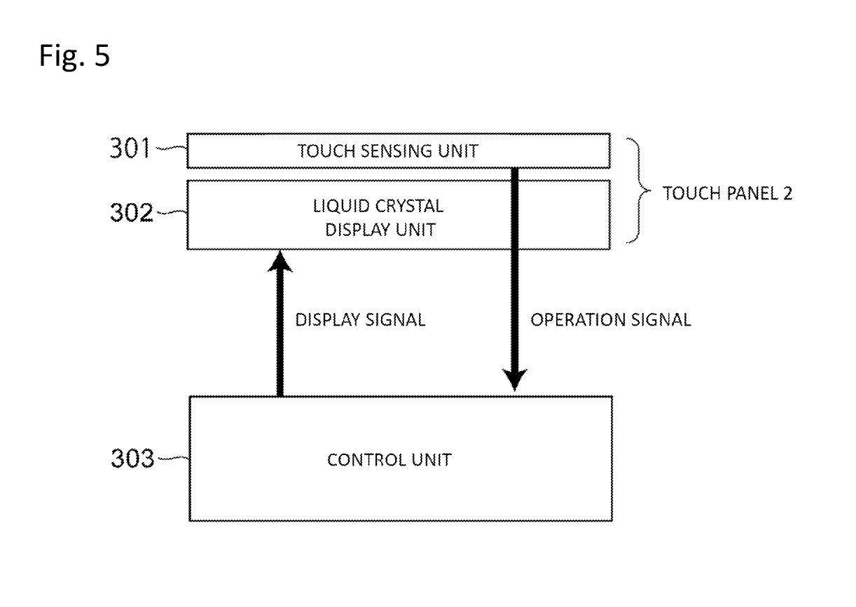

FIG. 5 is a block diagram the touch panel 2, in accordance with some embodiments. The touch panel 2 includes a touch sensing unit 301 corresponding to the input unit 8 and a liquid crystal display unit 302 corresponding to the display unit 7. The display unit 7 and the input unit 8 correspond to the touch panel 2 described above. Under control of the CPU 3, the touch panel 2 displays an image, receives an interactive touch operation (operation involving physical contact or the like on the touch panel 2) conducted by a game player, and displays graphics corresponding to the touch operation on the liquid crystal display unit 302 based on control of a control unit 303.

Specifically, the touch sensing unit 301 described above outputs an operation signal corresponding to the touch operation conducted by the user to the control unit 303. The touch operation can be conducted with any object, and may be conducted by, for example, a finger of the user or a stylus. As the touch sensing unit 301, for example, one having a capacitive type can be employed, but the present disclosure is not limited thereto. When detecting the operation signal received from the touch sensing unit 301, the control unit 303 determines that the user has conducted an instruction operation for the character, and conducts processing for transmitting graphics (not shown) corresponding to the instruction operation to the liquid crystal display unit as a display signal. The liquid crystal display unit 302 displays graphics corresponding to the display signal. In some embodiments, the display is other than a touch-sensitive display and is capable of outputting an image based on an instruction received from a processor.

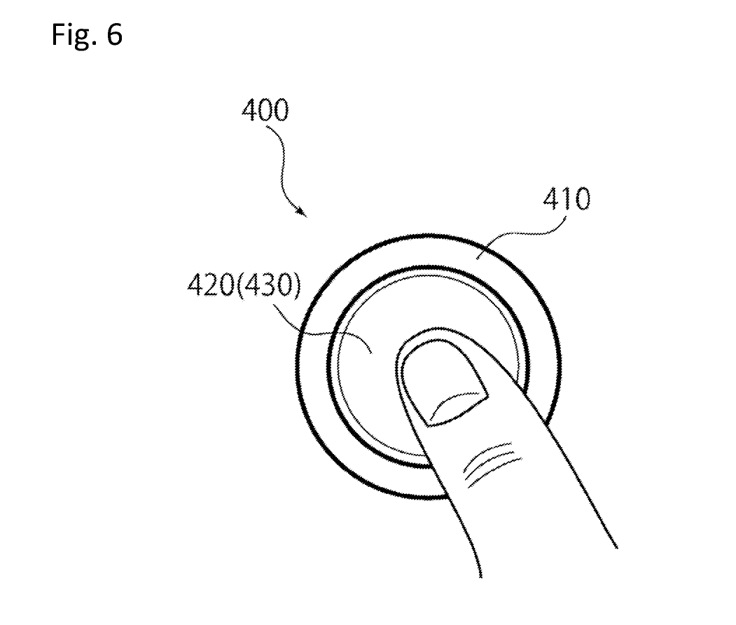

FIG. 6 to FIG. 8 are examples of a user interface, in accordance with some embodiments.

In FIG. 6, an operation object 400 includes a fixed circle 410 and an elastic object 420 positioned inside the fixed circle 410. The operation object 400 is displayed on the touch panel 2 when it is detected that a contact with the touch panel 2 has been made. In some embodiments, the contact is made by way of a user's finger coming into contact with the touch panel. The elastic object 420 is formed to have an initial shape around a contact point on the touch panel 2. In some embodiments, the initial shape is exhibited when the finger of the user comes into contact with the touch panel 2. In some embodiments, the initial shape is formed with the contact point being set as the center, but the present disclosure is not necessarily limited thereto. In some embodiments, the initial shape is formed displaced upward or downward by a given distance from the contact point. The displacement by a given distance can prevent the intial shape from being hidden by the finger of the user when the initial shape is displayed. In some embodiments, the initial shape is circular. In other embodiments, the initial shape is an ellipse, a square, a rectangle, a triangle, a rhombus, a parallelogram, a pentagon, a hexagon, an octagon, some other suitable polygon, some other suitable shape having at least one curved sidewall, or some other suitable shape having an entirely curved sidewall.

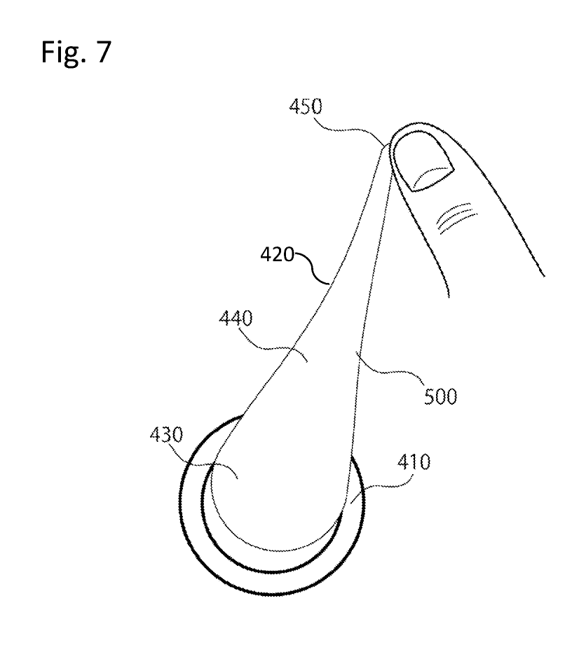

In FIG. 7, the elastic object 420 is illustrated as being stretched, in accordance with some embodiments. The elastic object 420 is configured to behave like an elastic body based on the user's interaction with the user interface. For example, the elastic object 420 is configured to be stretched based on the user's operation of the touch panel 2. In some embodiments, when the user conducts a slide operation on the touch panel 2 (operation for moving the contact point from a contact start point to a contact end point on the touch panel 2), the elastic object 420 exhibits such an elastic deformation as to be pulled by the finger of the user. In some embodiments, elastic object 420 includes a base portion 430 positioned in the contact start point of the slide operation, the position of which is fixed, a tip portion 450 positioned near the contact end point of the slide operation (note that, the finger is in a contact state), and a connecting portion 440 connecting the base portion 430 and the tip portion 450 to each other. (Note that, the base portion 430, the connecting portion 440, and the tip portion 450 may be hereinafter referred to collectively as “elastic object 420”.)

In this manner, the elastic object is formed so as to be elastically stretched in a direction in which the slide operation has been conducted. That is, the initial shape is stretched toward the contact end point, to thereby form and display an elastic object 420′ that has been elastically deformed. In some embodiments, the elastic object 420 is formed so as to cause the base portion 430 to become larger than the tip portion 450, but the present disclosure is not limited thereto. In some embodiments, the tip portion 450 may be formed to become larger than the base portion 430. In some embodiments, when the user further moves the contact end point on the touch panel while maintaining the contact state, the tip portion 450 further moves by following the movement, and a direction for stretching the elastic object 420 also changes.

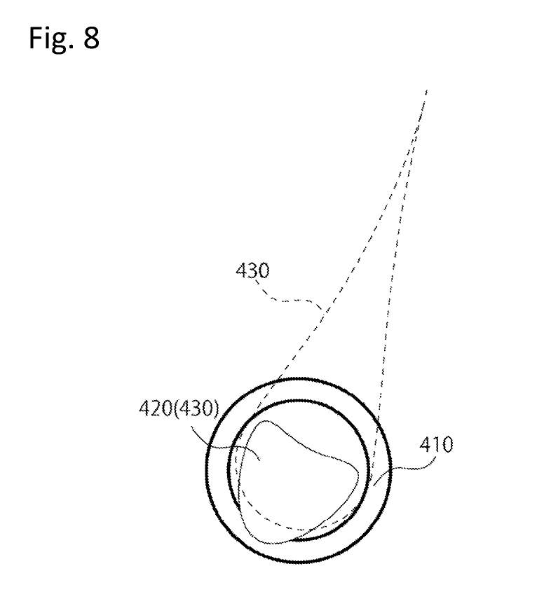

FIG. 8 illustrates the elastic object 420 when the user finishes the slide operation (that is, when the finger of the user comes off the contact end point on the touch panel 2), in accordance with some embodiments. In FIG. 8, the elastic object 420 that has been elastically deformed is contracted stepwise toward the contact start point in accordance with a restoring force of the elastic object, to thereby be displayed so as to restore the initial shape illustrated in FIG. 6. In this case, as illustrated in FIG. 8, the elastic object 420 is displayed so as to protrude from the fixed circle 410 in a contracting direction reverse to a stretching direction of the elastic object 420 as a reaction of the restoring force, and then restores the initial shape. The elastic object 420, as illustrated in FIG. 8, is deformed along with the restoration, but the present disclosure is not limited thereto. For example, the elastic object 420 may restore the initial shape without being subjected to such a deformation, and the position of the elastic object may be displaced so as to vibrate in the contracting direction reverse to the stretching direction.

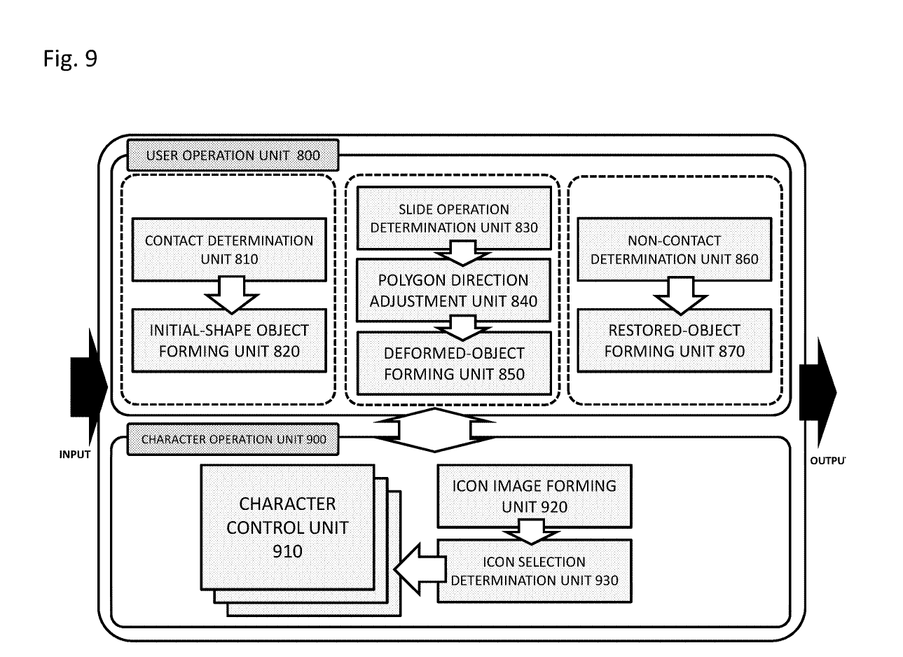

FIG. 9 is a diagram of a set of functions implemented based on a user interaction with the user interface, in accordance with some embodiments. Through the function set, an input serving as an operation signal is processed, and an output serving as a display signal is generated. The function set includes a user operation unit 800 relating to a user input operation to be conducted through the touch panel and a character operation unit 900 for operating a character by controlling the action of the character within the virtual space of a game based on an operation conducted on the touch panel. In the user operation unit 800, determination processing for a user input operation is conducted by each of a contact determination unit 810, a slide operation determination unit 830, and a non-contact determination unit 860, and based on results of the determination, processing for forming various objects is executed by an initial-shape object forming unit 820, a polygon direction adjustment unit 840 and a deformed-object forming unit 850, and a restored-object forming unit 870, which correspond to the contact determination unit 810, the slide operation determination unit 830, and the non-contact determination unit 860, respectively.

The contact determination unit 810 determines whether or not contact has been made on the touch panel with a physical body. When the contact determination unit 810 determines that contact has been made with a physical body, the initial-shape object forming unit 820 forms and displays an elastic object having a circular shape around the contact point on the touch panel. The slide operation determination unit 830 determines whether or not a slide operation has been conducted on the touch panel with the physical body. When the slide operation determination unit 830 determines that a slide operation has been conducted from the contact start point to the contact end point with the physical body, the polygon direction adjustment unit 840 conducts adjustment processing using a rotation of a polygon so that a direction of the polygon matches a moving direction of the physical body. Subsequently, the deformed-object forming unit 850 forms and displays a deformed elastic object by stretching the initial shape toward the contact end point.

When the slide operation is continued as it is, the polygon direction adjustment unit 840 further conducts polygon direction adjustment processing again, and the deformed-object forming unit 850 further stretches the deformed elastic object toward another contact end point. The non-contact determination unit 860 determines whether or not the physical body has come off the touch panel at the contact end point during the slide operation. When the non-contact determination unit 860 determines that the physical body has come off, the restored-object forming unit 870 contracts the elastic object deformed by the deformed-object forming unit 850 stepwise toward the contact start point, to thereby restore and display the elastic object having the initial shape formed by the initial-shape object forming unit 820.

Meanwhile, the character operation unit 900 controls the action of the character within the virtual space based on an operation conducted on the touch panel through the user operation unit 800. A character control unit 910 executes a character action based on a moving amount (moving distance) and a moving direction of the slide operation based on the slide operation determined by the slide operation determination unit 830, and displays the character action together with the deformed elastic object formed by the deformed-object forming unit 850. A large number of actions are assumed as character actions to be controlled by a character control unit, and are each associated with a given user operation and/or icon image.

When the elastic object having the initial shape is formed by the initial-shape object forming unit 820, an icon image forming unit 920 further generates and displays at least one icon image around the elastic object. An icon selection determination unit 930 determines whether or not the contact point on the touch panel corresponds to an arrangement position of the icon image. When it is determined by the slide operation determination unit 830 that the slide operation has been conducted, and when the icon selection determination unit 930 determines that the contact end point corresponds to the arrangement position of the icon image, the character control unit 910 executes the character action associated with the icon image.

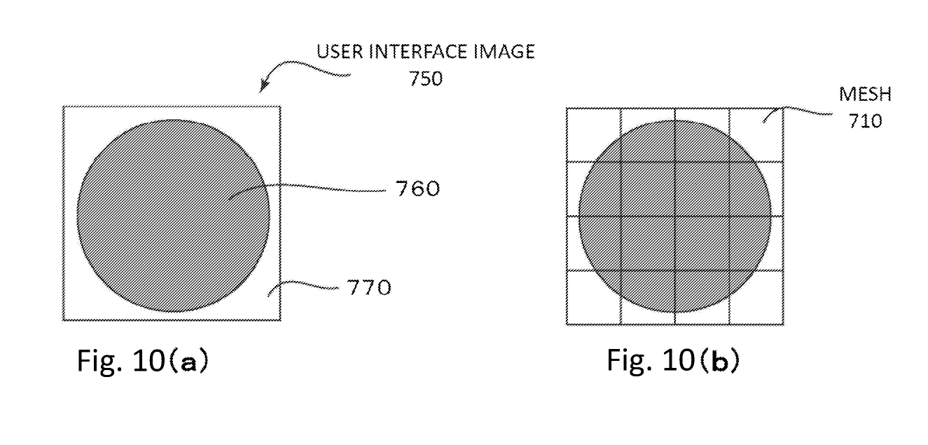

With reference to FIGS. 10 to 23, processing relating to the deformation of the elastic object, the basic configuration of which has been described above, is described with respect to several example embodiments.

FIGS. 10(a) and 10(b) are schematic illustrations of a user interface image of an elastic object having a circular shape, which is formed when the finger comes into contact with the touch panel 2, in accordance with some embodiments. As illustrated in FIG. 10(a), when the elastic object is displayed, an image is generated as a user interface image 750 having a substantially square shape, and is superimposed on a game image as a part thereof. The user interface image 750 is formed of a translucent region 760 and a transparent region 770, and the translucent region 760 is displayed on a screen as a basic display region of the elastic object.

More specifically, as illustrated in FIG. 10(b), the elastic object according to this embodiment is contained in a substantially square mesh region, and is formed as a polygon divided into a plurality of meshes 710. In FIG. 10(b), as an example, the user interface image 750 is divided into 4×4=16 meshes, and contains the elastic object, but it is understood by a person skilled in the art that there is no limitation imposed on the number of meshes for the division. Further, the deformation of the elastic object according to this embodiment is realized by virtually conducting processing for stretching the user interface image 750 like a rubber sheet, in particular, physical arithmetic operation processing for stretching the user interface image 750 in units of meshes (the processing is described later in detail).

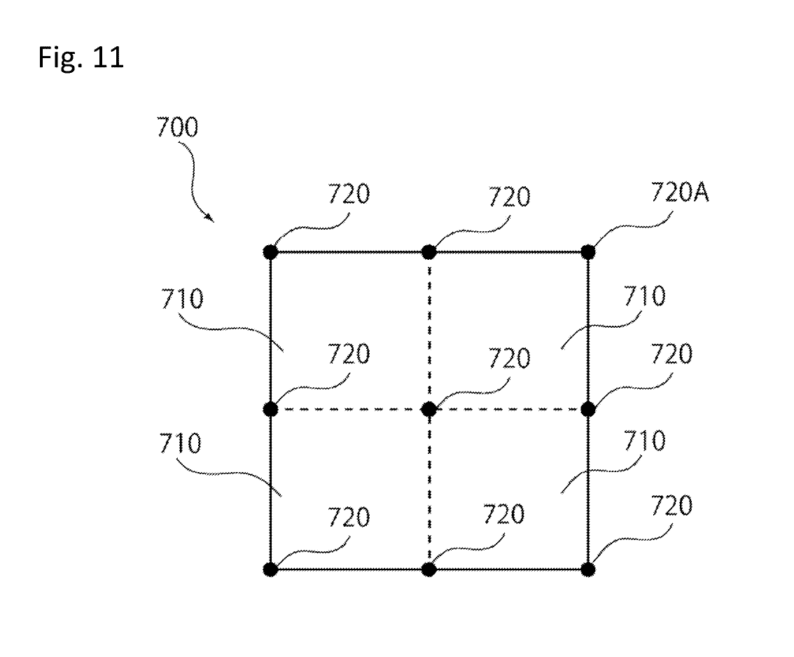

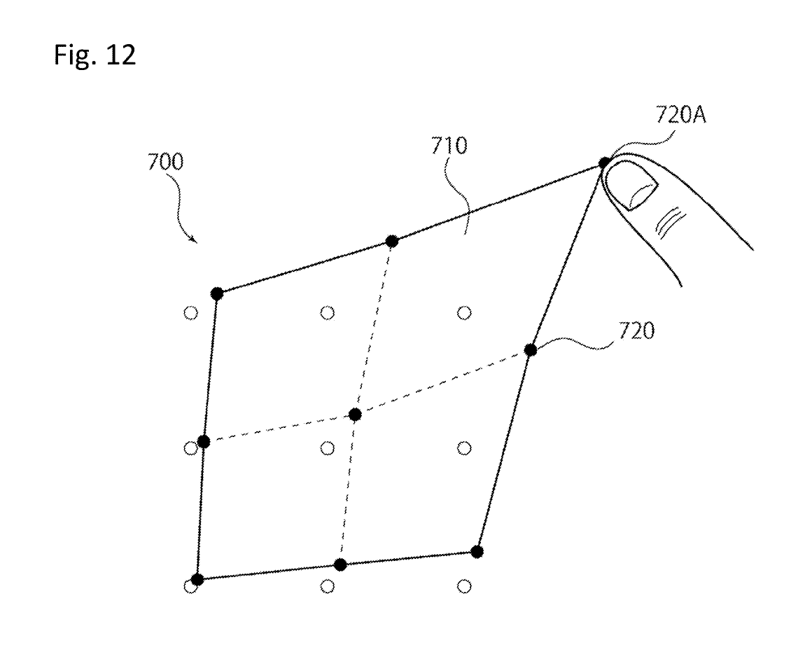

Next, with reference to FIG. 11 and FIG. 12, a description is made of the above-mentioned physical arithmetic operation processing for stretching the user interface image 750 in units of meshes. In FIG. 11 and FIG. 12, a part of the elastic object is schematically illustrated as an example. In some embodiments, the elastic deformation is expressed by moving coordinates of respective vertices 720 of a plate-like polygon 700 divided into the plurality of meshes 710. The respective vertices 720 are arranged in a mesh shape, and when the coordinates of an arbitrary vertex 720A are moved by the slide operation, the coordinates of other vertices 720 are also changed based on a moving vector (for example, moving direction and moving distance) relating to the vertex 720A. For example, the moving distances of the vertices 720 other than the vertex 720A may each be weighted based on a distance from the vertex 720A. That is, as illustrated in FIG. 12, a change amount of the coordinates may be set to become smaller as the distance from the vertex 720A becomes larger (as the coordinates becomes farther from the vertex 720A). The circles illustrated in FIG. 12 represent the positions of the vertices before the movement (that is, those illustrated in FIG. 11).

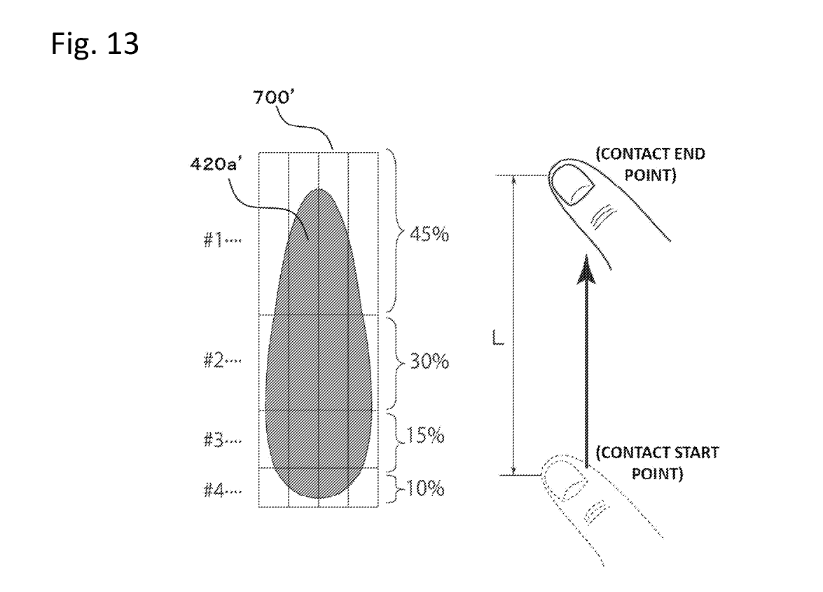

In view of the foregoing, further with reference to FIG. 13 and the subsequent figures, a description is made of various Examples of object deformation processing based on the above-mentioned basic principle.

### EXAMPLE 1

FIG. 13 is a schematic illustration of an example of an elastic object 420a deformed based on Example 1, in accordance with some embodiments. In this example, the deformed-object forming unit 850 stretches the initial shape generated by the initial-shape object forming unit 820 toward the end point along the direction of the slide operation, to thereby form a deformed elastic object 420a′. In particular, in the example of FIG. 13, when the coordinates of the respective vertices of the plurality of meshes obtained by the division are moved, each of the plurality of meshes is stretched such that, while the same rectangular shape is maintained for each of the columns (#1 to #4) (for example, meshes #1A to #1D all have the same rectangular shape), the meshes in the column (#1) closer to the contact end point become progressively longer than the meshes in the farther column (#4). As an example, the respective columns may be configured to have stretching factors subjected to weighted distribution based on a moving distance L exhibited by the slide operation.

In the example of FIG. 13, the respective columns are distributed such that #4 accounts for 10%, #3 accounts for 15%, #2 accounts for 30%, and #1 accounts for 45% (100% in total). In addition, when the moving distance is set as, for example, 2L, the respective columns may be subjected to weighted distribution so as to be further increased such that #4 accounts for 1%, #3 accounts for 4%, #2 accounts for 35%, and #1 accounts for 60%.

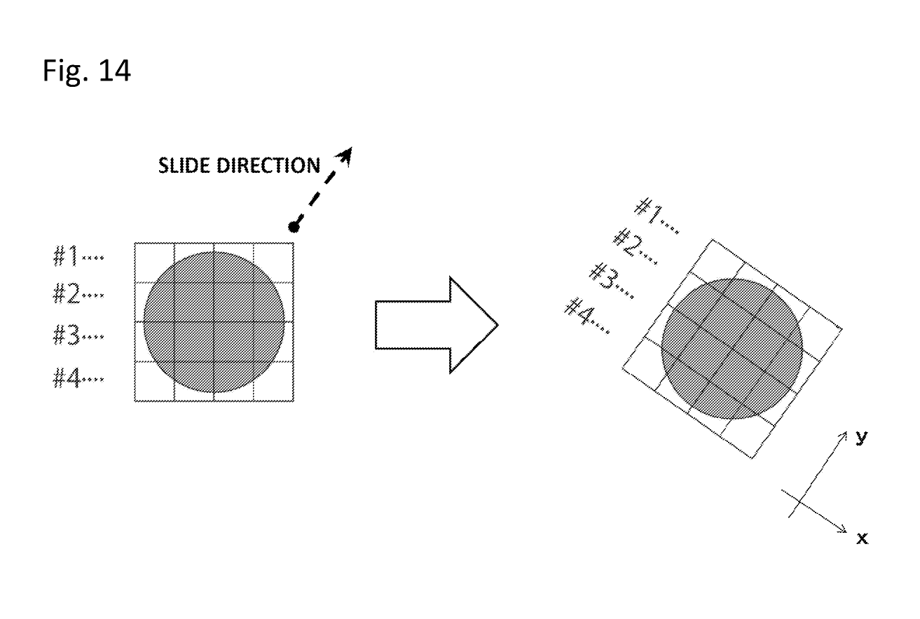

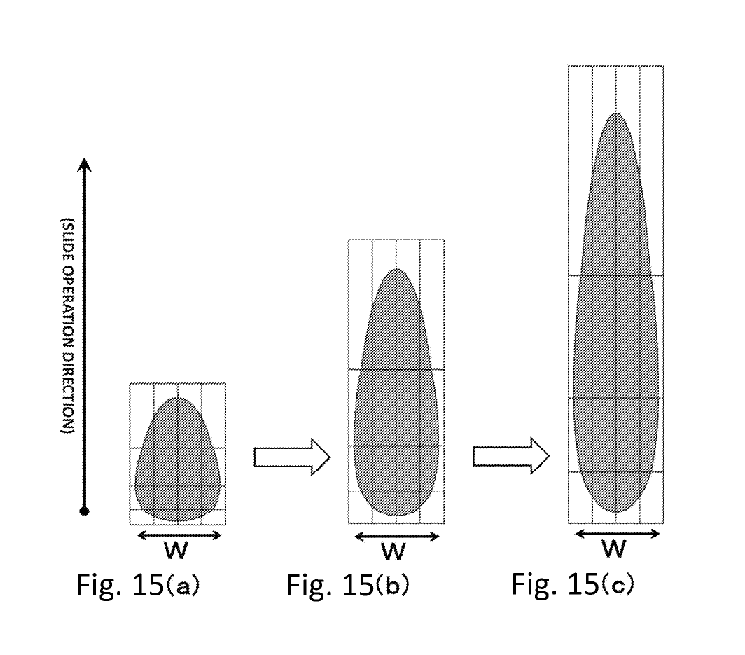

In this example, as schematically illustrated in FIG. 14, the polygon direction adjustment unit 840 first conducts the adjustment processing using the rotation of the polygon (polygon direction adjustment processing) so that the direction of the polygon matches the moving direction of the physical body. By conducting the polygon direction adjustment processing, as schematically illustrated in FIGS. 15(a)-15(c), the deformed elastic object can be deformed while constantly having a fixed width W (diameter of the translucent region 760 having a circular shape illustrated in FIGS. 10(a) and 10(b)) with respect to a slide operation direction irrespective of the moving distance of the sliding. As can be understood by a person skilled in the art even in comparison with the related art illustrated in FIG. 2, the elastic object deformed according to this example can be made to differ from the related art in that the elastic object can be configured to constantly have the fixed width W, and that the elastic object is deformed by stretching the initial shape toward the contact end point, to thereby allow the elastic object to have a smooth curved shape.

Note that, this example is not limited to the fixing the width W described above with reference to FIGS. 15(a)-15(c) to the diameter of a circle, and may be configured to, for example, gradually increase the width W based on the slide operation. That is, an enlargement ratio may be set so that the width W is gradually increased as the moving distance increases as in FIG. 15(a), FIG. 15(b), and FIG. 15(c). This allows an amount of the slide operation to be visually recognized more easily by the user as a size of the elastic object.

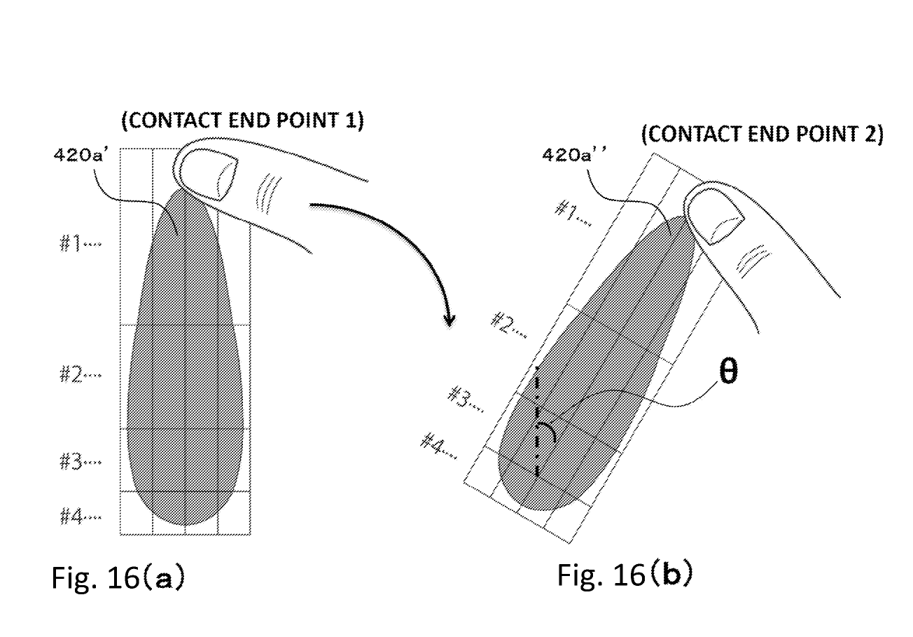

In relation to the polygon direction adjustment processing, as schematically illustrated in FIGS. 16(a) and 16(b), when the user further conducts the slide operation with the finger up to another contact end point 2 (FIG. 16(b)) without lifting the finger off a contact end point 1 (FIG. 16(a)), the deformation of the elastic object is continued. That is, the direction of the polygon is rotated by an angle between the contact end point 1 and the contact end point 2 with respect to the contact start point of the slide operation, to thereby rotate the deformed elastic object 420a′, and then the shape of the rotated elastic object is continuously stretched up to the end point 2, to thereby form a further deformed elastic object 420a″.

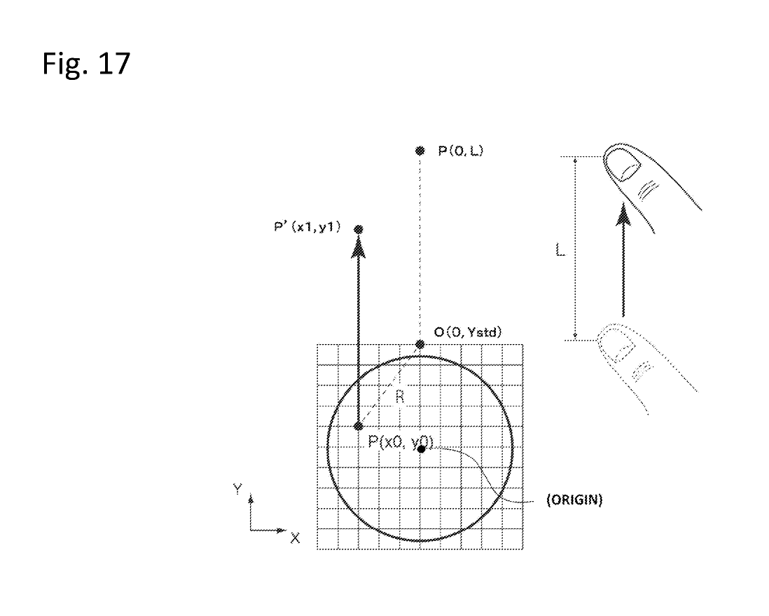

FIG. 17 is a schematic illustration of an example of an elastic object 420b deformed based on Example 2, in accordance with some embodiments. According to Example 2, the elastic object can be formed to have a curved shape smoother than in Example 1. Note that, in the same manner as in Example 1, the polygon direction adjustment processing is first conducted also in this processing example. Unlike in Example 1, this example is not limited to the stretching each mesh while maintaining the rectangular shape in each column (FIGS. 15(a)-15(c)). That is, in this example, first, one of mesh points on a line in the slide operation direction extending from the contact start point of the slide operation on the touch panel is set as a reference point O (0, Ystd).

It suffices that the vertices of the plurality of meshes for containing the elastic object to be deformed are subsequently determined based on the moving distance L of the slide operation and distances from the reference point O to the plurality of meshes (in particular, distances R from the reference point O to the respective vertices of the plurality of meshes). In this example, it is understood by a person skilled in the art that the rectangular shape in each column is not maintained in consideration of the fact that the distance R that differs for each vertex is used to calculate the coordinates.

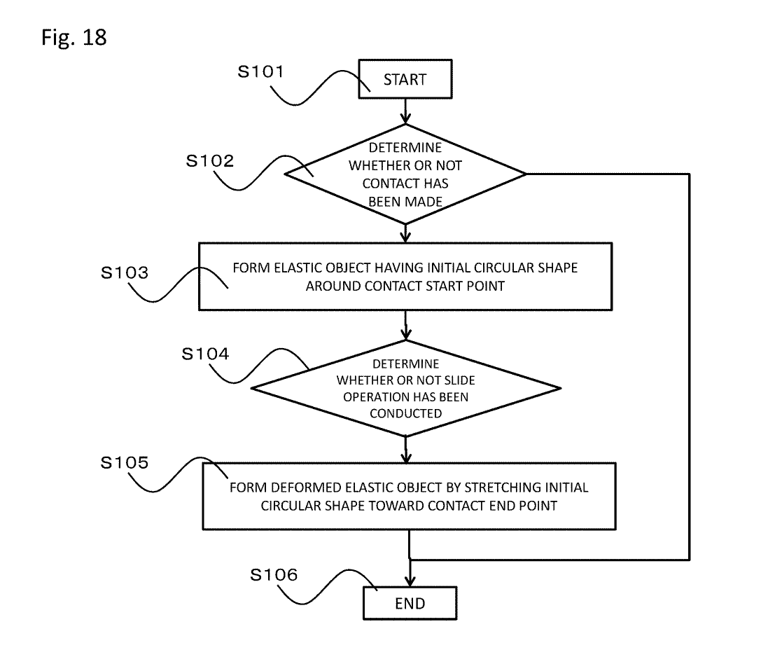

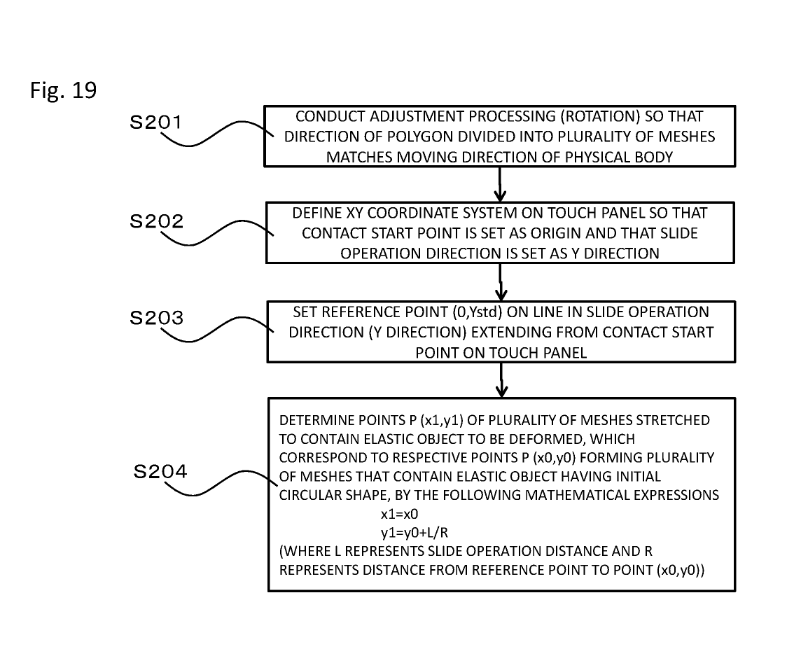

FIG. 18 and FIG. 19 are flowcharts of the processes performed in accordance with some embodiments.

As illustrated in FIG. 18, this example is started in Step S101, and in Step S102, the contact determination unit 810 determines whether or not contact has been made on the touch panel. When it is determined that contact has been made with a physical body (finger), the procedure advances to Step S103, and the initial-shape object forming unit 820 forms an elastic object having an initial shape around the contact start point (see also FIGS. 10(a) and (b)). The procedure then advances to Step S104, and the slide operation determination unit 830 determines whether or not a slide operation has been conducted on the touch panel with the physical body. When it is determined that a slide operation has been conducted, the procedure advances to Step S105, and the polygon direction adjustment unit 840 and the deformed-object forming unit 850 stretch the initial shape toward the contact end point, to thereby form a deformed elastic object.

Now, processing for forming the deformed elastic object conducted in Step S105 is described in more detail with reference to the flowchart of FIG. 19. When it is determined in Step S104 that a slide operation has been conducted, first, in Step S201, the polygon direction adjustment unit 840 conducts the polygon direction adjustment processing described above in Example 1 (see also FIG. 14). In this respect, also in this processing example, the elastic object 420b can be deformed while constantly having the fixed width W with respect to the slide operation direction. At the same time, in Step S202, XY coordinates on the touch panel are defined for the deformation of the elastic object 420b. This XY coordinate system is defined so that the contact start point is set as an origin and that the slide operation direction is set as a Y direction.

Subsequently, in Step S203, the reference point (0, Ystd) is set on the line in the slide operation direction (Y direction) extending from the contact start point on the touch panel. The reference point may be set at the vertices on an outer periphery of the polygon in the Y direction as illustrated in FIG. 17.

Then, in Step S204, when the elastic object is deformed, the deformed-object forming unit 850 transfers the respective vertices P (x0,y0) of the plurality of meshes that contain the elastic object having the initial shape. That is, respective corresponding vertices P′ (x1,y1) of the plurality of meshes are determined. In this case, assuming that L represents the moving distance and R represents the distance from the reference point (0, Ystd) to each point (x0,y0), each corresponding vertex P′ (x1,y1) corresponding to each vertex P (x0,y0) is calculated by the following mathematical expressions.

x1=x0

y1=y0+L/R

According to the above-mentioned mathematical expressions, it is understood by a person skilled in the art that a vertex having a larger distance R from the reference point to each point (x0,y0) is calculated as exhibiting less movement in the Y direction and moves less far. Step S204 is conducted for all the vertices of the plurality of meshes, to thereby determine all the corresponding vertices of the stretched meshes, with the result that a deformed elastic object is formed. The elastic object formed by the deformed-object forming unit 850 does not need to maintain the rectangular shape unlike in Example 1, and hence a smoother curved shape can be formed.

Returning to FIG. 18, this processing ends in Step S106. Although not shown, when the user continuously causes the finger to make a slide action after Step S106 of FIG. 18, as illustrated also in Example 1, the elastic object is continuously further deformed. That is, the polygon direction adjustment unit 840 rotates the direction of the polygon by the angle between the contact end point 1 and the contact end point 2 with respect to the contact start point of the slide operation, to thereby rotate the deformed elastic object. Subsequently, the deformed-object forming unit 850 stretches the shape of the rotated elastic object up to the end point 2, to thereby form a further deformed elastic object.

On the other hand, after Step S106, when the non-contact determination unit 860 determines that the user has lifted the finger off the touch panel, as described above with reference to FIG. 8, the restored-object forming unit 870 contracts the elastic object that has been elastically deformed stepwise toward the start point in accordance with a restoring force of the elastic object. Finally, the initial shape illustrated in FIG. 6 is restored. It is understood by a person skilled in the art that the contracting processing can be realized by appropriately selecting the reference point (0, Ystd) again stepwise, and conducting a calculation based on the above-mentioned mathematical expressions through use of the moving distance and the distances from the selected reference point (0, Ystd) to the respective points (x0,y0).

### EXAMPLE 3

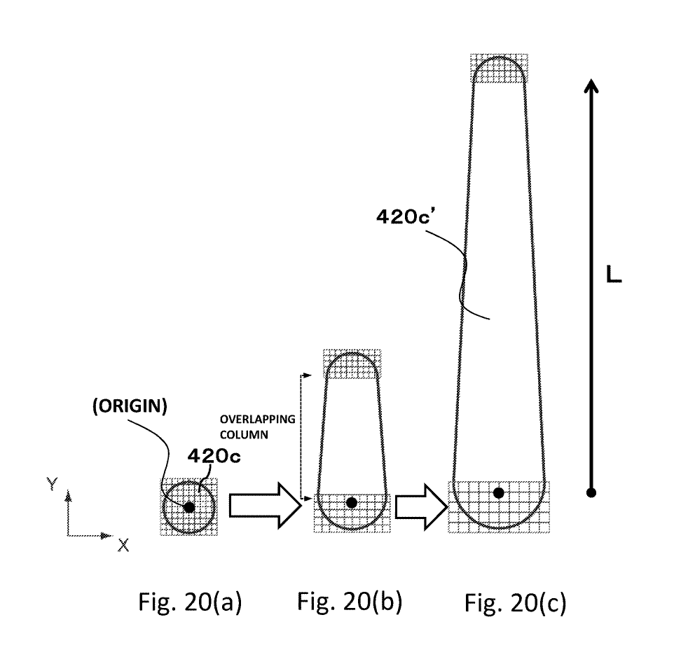

FIGS. 20 (a)-20(c) are schematic illustrations of an example of an elastic object 420c deformed based on Example 3, in accordance with some embodiments. According to Example 3, compared to Examples 1 and 2, an elastic object 420c′ can be further formed to have a more dynamic curved shape in association with the slide operation of the physical body. In the same manner as in Examples 1 and 2, the polygon direction adjustment processing is first conducted also in this example An overall outline of deformation processing according to this example is substantially the same as that of the flowchart of FIG. 18 described in Example 2.

Meanwhile, in this example, unlike in Example 2, the deformed-object forming unit 850 does not stretch each of the plurality of meshes along the direction of the slide operation. Instead, in this example, the deformed-object forming unit 850 divides the elastic object having the initial shape into two portions based on mesh regions, and enlarges one mesh region portion, while moving the other mesh region to the periphery of the contact end point. Then, these are connected to each other, to thereby form a deformed elastic object.

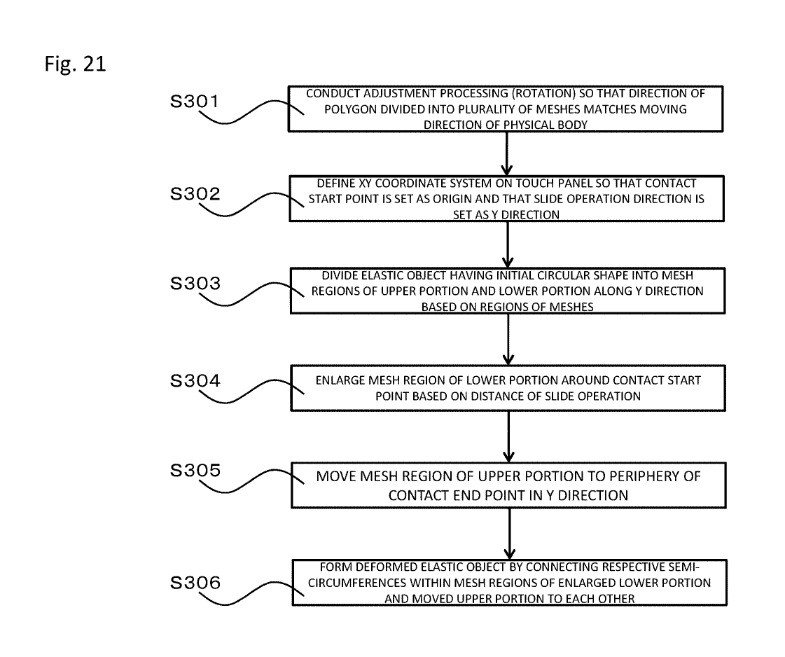

Details of this example (in particular, details of Step S105 of FIG. 18) are described with reference to a flowchart of FIG. 21. When the slide operation determination unit 830 determines in Step S104 of FIG. 18 that the slide operation has been conducted, first, in Step S301, the polygon direction adjustment unit 840 conducts the polygon direction adjustment processing as described above also in Example 1. At the same time, in Step S302, XY coordinates on the touch panel may be defined for the deformation of the elastic object 420c. This XY coordinate system is defined so that, as illustrated in FIG. 20(a), the contact start point is set as the origin and that the slide operation direction is set as the Y direction.

Subsequently, in Step S303, the deformed-object forming unit 850 divides the elastic object having the initial shape into two mesh regions of an upper portion and a lower portion based on a plurality of mesh regions. In this case, the two mesh regions are formed by dividing the initial shape into two equal halves. For example, if the initial shape is circular, the initial shape is divided into semicircles in a direction (X direction) perpendicular to the slide operation direction (Y direction). In some embodiments, the two mesh regions of the upper portion and the lower portion may have an overlap in a part thereof, and in the example of FIG. 20(b), has an overlapping column corresponding to one column

Then, in Step S304, the deformed-object forming unit 850 first enlarges the mesh region of the lower portion around the contact start point with an enlargement ratio corresponding to the moving distance L of the slide operation. This increases the size of the mesh region around the contact start point as the slide operation distance L becomes longer, as understood by a person skilled in the art even in comparison with the sizes of the mesh regions of the lower portions of FIG. 20(b) and FIG. 20(c). That is, the mesh region may be formed so as to be enlarged with a large semi-circumference in the slide operation direction (Y direction) and/or the direction (X direction) perpendicular to the slide operation direction. Subsequently, in Step S305, the deformed-object forming unit 850 next moves the mesh region of the upper portion to the periphery of the contact end point in the Y direction.

In FIG. 20(b) and FIG. 20(c), the size of the mesh region of the upper portion is set to be the same. That is, in this case, the size of the mesh region of the upper portion is not based on the slide operation distance L. However, in the same manner as the case of the lower portion, the size of the mesh region of the upper portion may also be formed so as to be enlarged based on the slide operation distance L. In this case, the enlargement ratio of the upper portion may be determined in association with the enlargement ratio of the lower portion used in Step S304. Specifically, in order to form the elastic object 420c′ according to this example to have such a shape as to be tapered toward the tip along the direction of the slide operation, the enlargement ratio of the upper portion may be set smaller than the enlargement ratio of the lower portion used in Step S304.

Finally, in Step S306, the deformed-object forming unit 850 forms a deformed elastic object by connecting the respective semi-circumference portions within the mesh regions of the lower portion enlarged in Step S304 and the upper portion moved in Step S305 to each other. For example, the semi-circumference portions on the overlapping columns illustrated in FIG. 20(b) are connected to each other. As a connection manner, the semi-circumference portions may be connected by straight lines as illustrated in FIG. 20(b) and FIG. 20(c), but in addition, in order to form the elastic object to have a smoother curved shape, such an arbitrary effect process as to stretch connection lines in the X direction may be conducted.

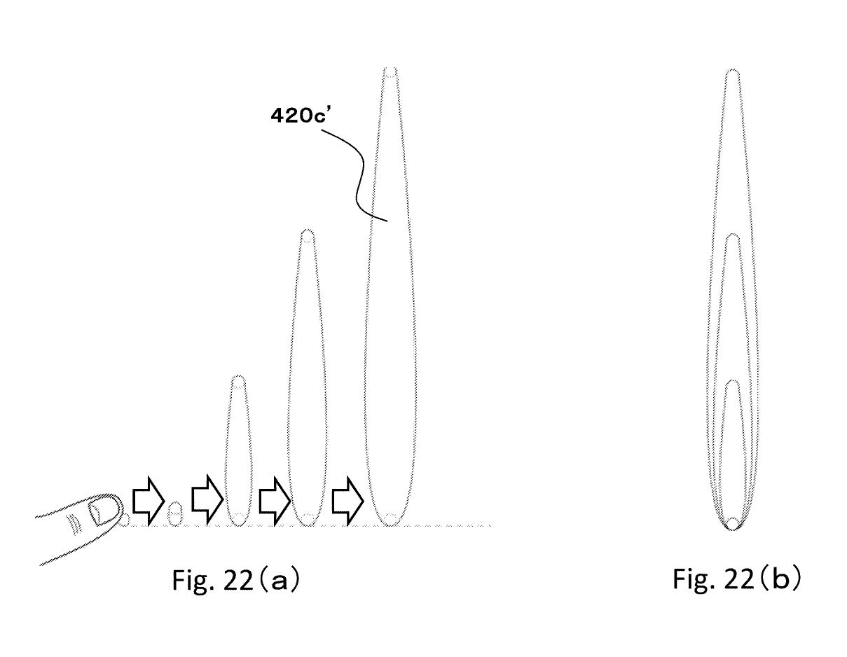

FIGS. 22(a) and 22(b) are schematic illustrations of a series of elastic objects 420c formed to have smoother curved shapes. In FIG. 22(a), how the series of elastic objects 420c change is illustrated in time series, and in FIG. 22(b), the respective elastic objects are illustrated so as to be superimposed on one another. As illustrated in FIGS. 22(a) and 22(b), the lower portion of the initial shape is enlarged to become larger based on the slide operation distance, and hence it is understood by a person skilled in the art that the width of the elastic object 420c becomes larger as the slide operation distance becomes larger. This example is different in the shape from Examples 1 and 2 involving the fixed width. In this example, by increasing the width of the elastic object 420c, the elastic object 420c′ can be formed to have a more dynamic curved shape in association with the slide operation of the physical body.

Although not shown, when the user continuously conducts a slide operation with the finger on the touch panel after Step S106 of FIG. 18, as described also in Examples 1 and 2, the elastic object is further deformed. That is, the polygon direction adjustment unit 840 rotates the direction of the polygon by the angle between the contact end point 1 and the contact end point 2 with respect to the contact start point of the slide operation, to thereby rotate the deformed elastic object. Subsequently, the deformed-object forming unit 850 stretches the shape of the rotated elastic object up to the end point 2, to thereby form a further deformed elastic object.

On the other hand, after Step S106, when the non-contact determination unit 860 determines that the user has lifted the finger off the touch panel, as described above with reference to FIG. 8, the restored-object forming unit 870 contracts the elastic object that has been elastically deformed stepwise toward the start point in accordance with a restoring force of the elastic object, to thereby restore the initial shape illustrated in FIG. 6. It is understood by a person skilled in the art that the contracting processing can be realized by appropriately determining stepwise the enlargement ratio depending on the slide operation distance used in Step S304, and conducting the respective processing steps of from Step S302 to Step S306.

### EXAMPLE 4

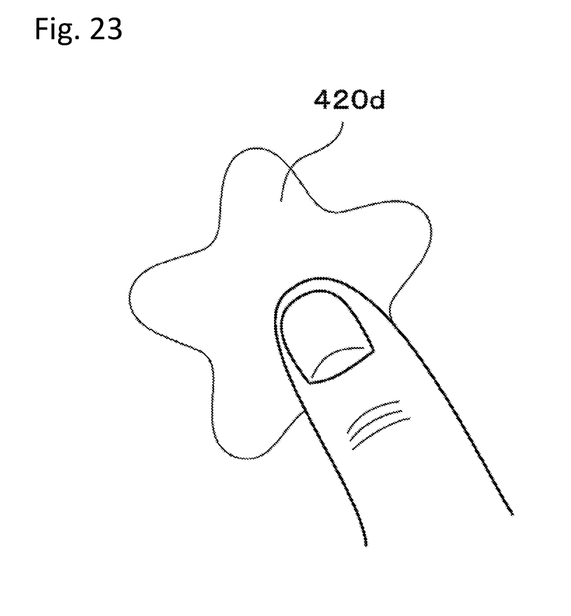

FIG. 23 is a schematic illustration of an example of an elastic object deformed based on Example 4, in accordance with some embodiments. As illustrated in FIG. 23, as a modification example of this embodiment, when a tap operation (operation for conducting a touch (instantaneous contact operation) on the touch panel 2) is conducted, an elastic object 420d is displayed at a tap operation point under the state of being elastically deformed as if the elastic object 420d were crushed. An outer periphery of an elastic object 420d is formed of a sine curve expressed by the following general expression. In this embodiment, the values of A, ω, and T are randomly defined within a predetermined limiting range. This allows the shape of the elastic object to be deformed at random, and to become closer to the shape of the outer periphery exhibited when an elastic body is crushed in reality.

y=A sin(ωt+T)

Note that, the shape of the elastic object 420d illustrated in FIG. 23 may be changed based on a parameter used in the game. For example, in a competitive RPG, the size and shape of a star may be changed by a magnitude of damage given to an opponent character, the type or the like of a weapon used by the game character, moreover, an occurrence of a continuous combo (a series of attacks made to the opponent character), and the like.

Application Example of User Interface

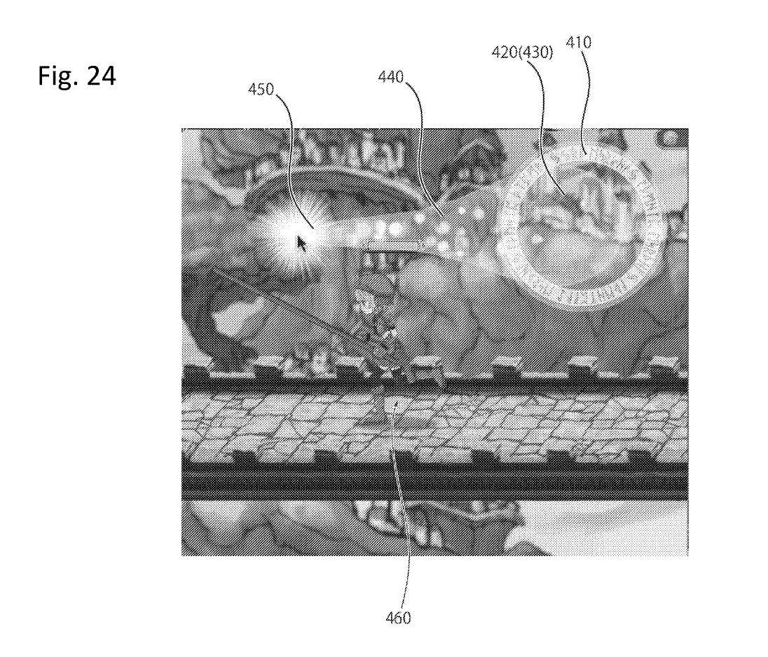

With reference to FIG. 24 to FIG. 32, a description is made of application examples of applying the user interface of the elastic object to a game, in accordance with some embodiments. FIG. 24 to FIG. 27 are screen examples obtained when a game program including the user interface are executed by a processor. A competitive RPG configured so that a game object (for example, game character) arranged in a virtual space within a game and displayed on the touch panel is operated with the physical body such as the finger of the user is assumed as a smartphone game. This game program is implemented based on any one of the various Examples described above. In response to the slide operation of the user, a character action based on the moving direction and the moving distance of the slide operation is executed, and the character action is displayed together with the deformed elastic object.

### GAME APPLICATION EXAMPLE 1

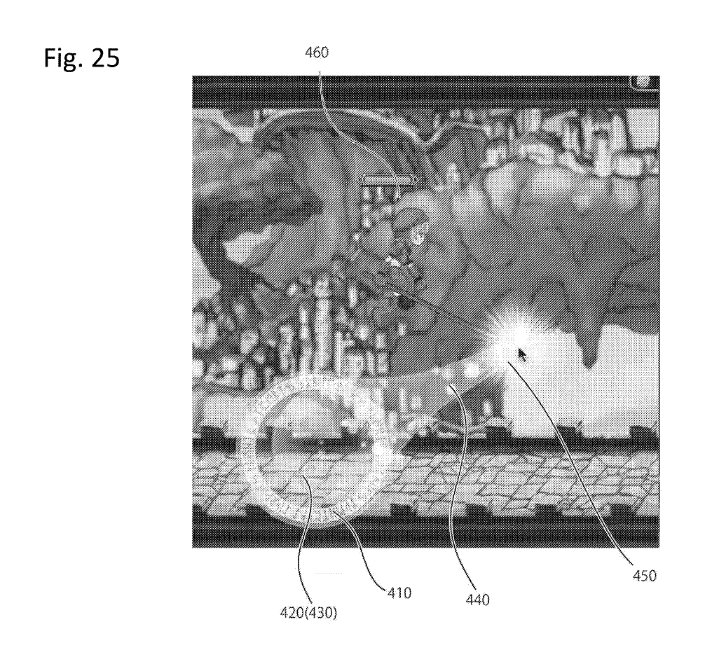

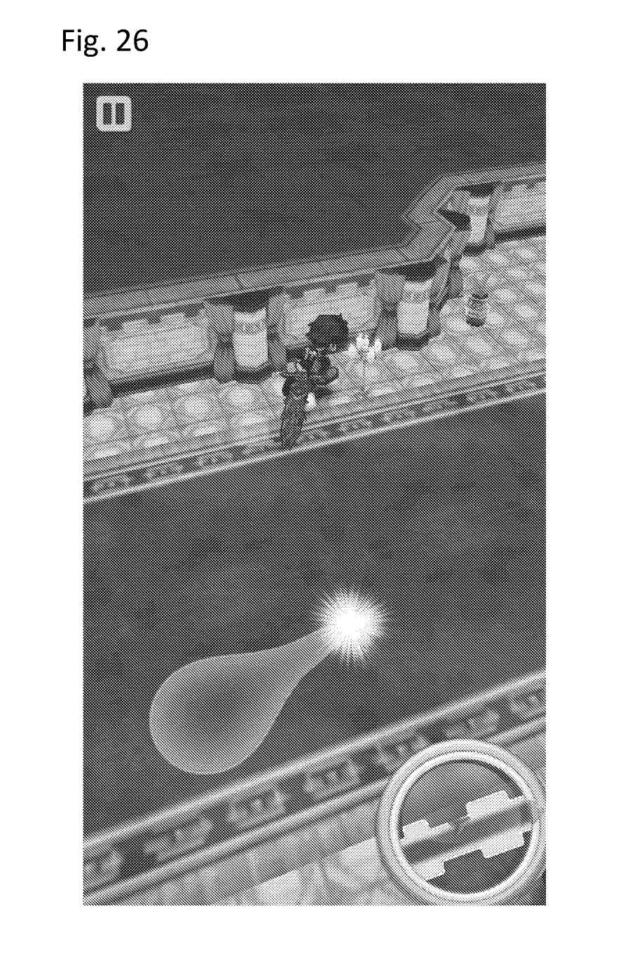

FIG. 24, FIG. 25, and FIG. 26 are game screen examples obtained when the game program including the user interface implemented based on Example 1 or Example 2 is executed. In response to the slide operation of the user, the character control unit 910 executes a character moving action based on the moving distance and the moving direction of the slide operation, and displays the character moving action together with the deformed elastic object.

As illustrated in FIG. 24, when the user conducts a slide operation toward the left direction on the touch panel 2, the elastic object 420 is displayed so as to be elastically deformed toward the left direction. In response to this operation, an action for causing a game character 460 to move toward the left direction is executed. On the other hand, as illustrated in FIG. 25, when the user conducts a slide operation toward the upper (right) direction on the touch panel 2, the elastic object 420 is displayed so as to be elastically deformed toward the upper (right) direction. In response to this operation, an action for causing the game character 460 to jump toward the upper (right) direction is executed.

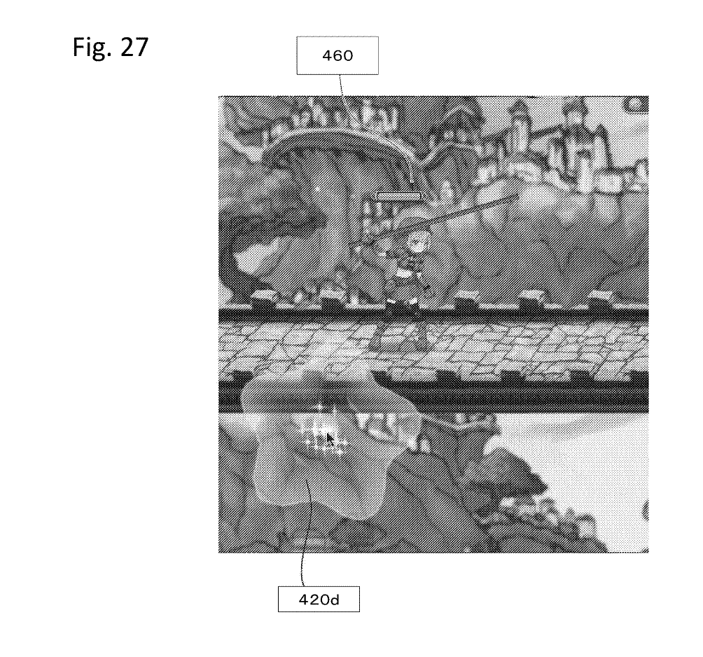

FIG. 24 and FIG. 25 are the game screen examples of a game in a two-dimensional virtual space, while the game screen of FIG. 26 is the screen example of a game in a three-dimensional virtual space. The same applies to the three-dimensional virtual space, and as illustrated in FIG. 26, when the user conducts a slide operation toward the upper right direction on the touch panel 2, the elastic object 420 is displayed so as to be elastically deformed toward the upper right direction. In response to this operation, the game character 460 three-dimensionally moves toward the upper right direction. Further, FIG. 27 is a screen example of a case where the game program including the user interface implemented based on Example 4 is executed. This screen example is an example of executing and displaying an attacking action made by a character in response to the user's operation. When the user conducts a tap operation on the touch panel 2, the elastic object 420d implemented based on Example 4 is displayed. In response to this operation, the game character 460 executes the attacking action.

### GAME APPLICATION EXAMPLE 2

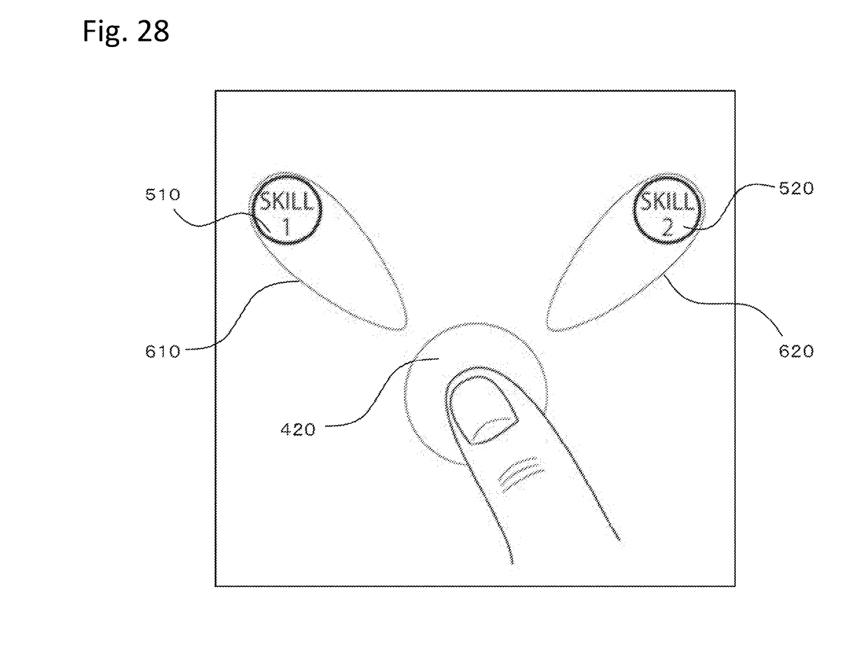

FIG. 28 is a user interface image example of a case where the user interface implemented based on any one of Example 1 to Example 3 is at least executed, in accordance with some embodiments. This user interface image example is displayed in a predetermined case where the user touches the touch panel. As illustrated in FIG. 28, in addition to the elastic object 420 having the initial shape, a set of icon images 510 and 520, which are arranged so as to be spaced apart from the elastic object 420 and in which “SKILL” is written, and elastic objects 610 and 620 having substantially elliptic shapes, which are formed so as to include the icon images 510 and 520, respectively, are superimposed as the user interface image.

The user interface image is operated by the icon image forming unit 920 so as to appear when, for example, a contact state of the finger of the user is continued for a fixed period of time (that is, the user presses and holds on the touch panel). In a state in which the user interface image is displayed, when the user conducts a slide operation with the finger, it is possible to execute the action of moving the character based on the slide operation while deforming the elastic object 420 as in Game Application Example 1.

Subsequently, when the icon selection determination unit 930 determines that there is a slide operation for selecting the icon image 510 or 520, the character control unit 910 interrupts the moving action of the character, and executes the selected “SKILL” icon. Specifically, it is determined whether or not a slide contact end point on the touch panel is in the arrangement position of the icon image, and when the slide contact end point is in the arrangement position, a character action associated with the “SKILL” icon is executed. Note that, the “SKILL” used herein represents a character action associated with the icon image 510 or 520, and can be, for example, one of attacking actions to be made by the game character within the game. During the moving action of the character based on the slide operation, the icon images 510 and 520 are continuously displayed unless the state of contact with the touch panel is released.

That is, it is possible to cause the character to make a moving action within the virtual space while constantly maintaining a state capable of executing the “SKILL” (this movement is hereinafter referred to as “run-up movement”; specific processing thereof is described later). Note that, according to this application example of FIG. 28, two “SKILL” icons (510 and 520) are radially arranged in upper left and upper right distant positions in the periphery of the elastic object 420. However, it is to be understood that no limitations are imposed on the positions and the numbers of those icons. For example, this may apply to four kinds of “SKILL” arranged not only in the upper left and upper right positions but also in lower left and lower right positions.

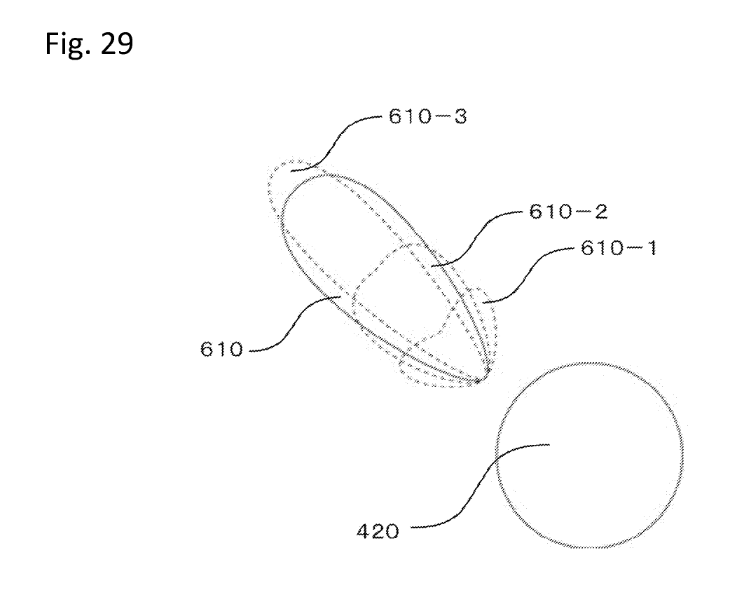

The elastic object 610 and 620 behave so as to form substantially elliptic shapes as objects that can be elastically deformed as illustrated in FIG. 29. Specifically, when the finger of the user comes into contact with the touch panel and the contact is maintained for a fixed period of time, the elastic object 610 undergoes a stepwise elastic deformation including a shape 610-1, a shape 610-2, and a shape 610-3 indicated by the dotted lines, and finally becomes a shape denoted by reference numeral 610 and indicated by the solid line. By conducting such display as to exert a pop-up feel, it is possible to present a special feel about the operation. Note that, the elastic objects 610 and 620 can also be formed by the icon image forming unit 920 by gradually stretching the initial shape toward the icon image in the same manner as in the various Examples described above. Further, in FIG. 29, the elastic object 610 is illustrated for the sake of brevity, but the same applies to the elastic object 620.

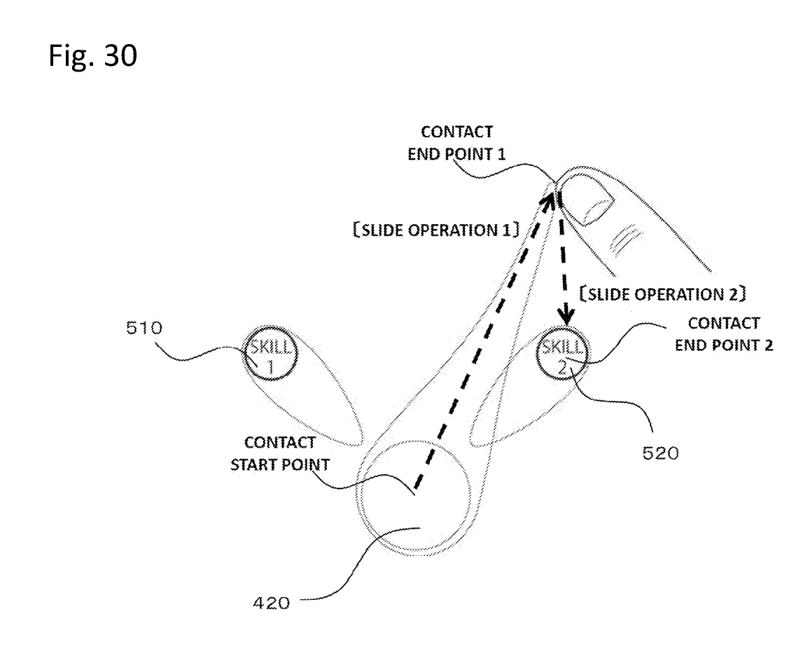

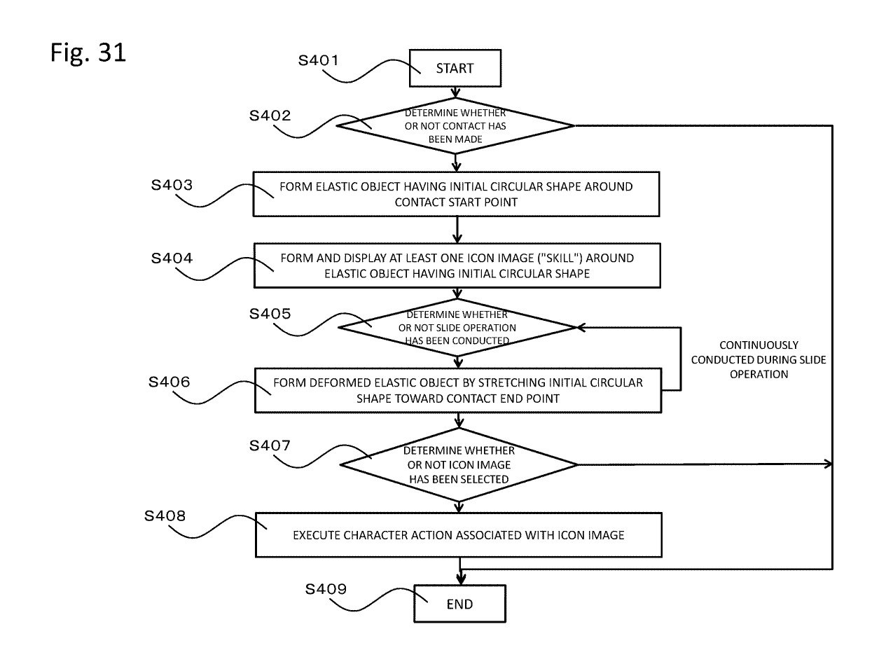

The above-mentioned run-up movement processing is described below with reference to a schematic diagram of FIG. 30 and a flowchart of FIG. 31. FIG. 30 is a schematic diagram for illustrating the run-up movement of the game character. In this case, such a scenario is assumed that the user presses and holds the contact start point on the touch panel, then conducts a slide operation up to the contact end point 1 (slide operation 1), and is about to further conduct a slide operation up to the contact end point 2. As illustrated in FIG. 30, as the user interface image, both the elastic object 420 and the “SKILL” icon images 510 and 520 are displayed. Even after the slide operation 1, when the user further conducts the slide operation 2 up to the “SKILL2” icon 520 without lifting the finger, the “SKILL2” action is enabled.

By conducting this application example, it is enabled to execute an action for causing a character to move within the virtual space while constantly maintaining the state capable of executing “SKILL”. In particular, in a smartphone game that requires a high operation speed, enabling the execution of two actions with a continuous slide operation leads to an improvement in usability thereof.

With reference to the flowchart of FIG. 31, details of the run-up movement processing is described. In FIG. 31, for the sake of brevity, no consideration is given to the display processing for the elastic objects 610 and 620. The run-up movement processing is started in Step S401, and in Step S402, the contact determination unit 810 determines whether or not contact has been made on the touch panel. When it is determined that contact has been made with a physical body (finger), the procedure advances to Step S403, and the initial-shape object forming unit 820 forms an elastic object having an initial shape around the contact start point (see also FIGS. 10(a) and 10(b)). At the same time, for example, when the contact state is continued for a fixed period of time (the user presses and holds), the procedure further advances to Step S404, and the icon image forming unit 920 radially generates and displays at least one icon image (“SKILL” icon) around the elastic object having the initial shape, which is formed in Step S403.

Subsequently, in Step S405, the slide operation determination unit 830 determines whether or not a slide operation has been conducted on the touch panel with the physical body. When it is determined that a slide operation has been conducted, the procedure advances to Step S406, and the polygon direction adjustment unit 840 and the deformed-object forming unit 850 stretch the initial shape toward the contact end point 1, to thereby form a deformed elastic object. Step S406 is continuously conducted during the slide operation. When the slide operation is finished (contact end point 2), the procedure subsequently advances to Step S407, and the icon selection determination unit 930 determines whether or not the contact end point 2 of the slide operation corresponds to the arrangement position of the icon image. When it is determined that a slide operation has been conducted from the contact end point 1 to the contact end point 2 (Step S405), and when it is determined that the contact end point 2 corresponds to the arrangement position of the icon image (Step S407), the procedure advances to Step S408, and the character control unit 910 executes the character action “SKILL” associated with the icon image. Finally, the procedure advances to Step S409 to bring the run-up movement processing to an end.

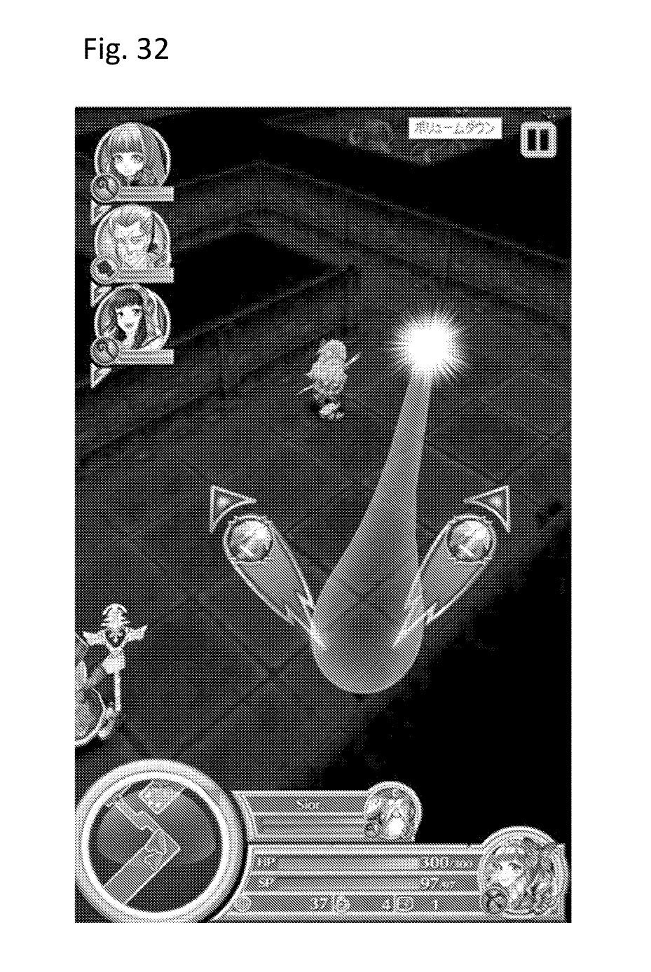

FIG. 32 is an illustration of a game screen example of the case where the game program including the user interface that implements the run-up movement processing is executed. In FIG. 32, the user interface of FIG. 30 is superimposed on the game screen. An icon image of a sword is displayed on the “SKILL” icon portion of FIG. 30, and when selected, enables a powerful attack using a specific weapon. In this screen example, as the run-up movement, it is enabled to move the game character based on the elastic object while keeping displaying the icon image. In this respect, in consideration of usability of the user who conducts an operation, it is desired to set the moving speed of the game character somewhat slower in a mode of displaying the icon image together than otherwise.

The elastic object displayed by the user interface according to the present disclosure is configured to associate the amount of a slide operation conducted by the user (that is, moving distance of the finger on the touch panel) and the moving distance of a game character with each other. Therefore, when the elastic object is displayed, it becomes easy to recognize a magnitude (moving distance) of the movement instruction issued to the game character in a physically sensed manner Further, it becomes easy to recognize a controller that is liable to be hidden by the finger, such as a related-art virtual joystick (see FIG. 1). In addition, the elastic object is displayed together with the icon image, to thereby be able to improve the usability in the smartphone game that requires a high operation speed.

The user interface for deforming and displaying the shape of the elastic object on the touch panel of the mobile terminal and the game program to be used for the game configured so that the action of the character within the virtual space is controlled and displayed based on the operation conducted on the touch panel of the mobile terminal, according to the embodiment of the present disclosure, have been described along with the various Examples and game application examples.

An aspect of this description is related to a method that comprises detecting a first input indicative of a first position in an image output by a display, detecting a second input indicative of a second position in the image different from the first position, and causing an object to be output by the display based on the first input or the second input. The object comprises a boundary having a first end closer to the first position than to the second position, and a second end closer to the second position than to the first position. The first end of the boundary is displayed having a first distance between a first edge of the boundary and a second edge of the boundary along a first axis connecting the first edge of the boundary, the second edge of the boundary and a first point within the boundary. The second end of the boundary is displayed having a second distance between the first edge of the boundary and the second edge of the boundary along a second axis parallel to the first axis connecting the first edge of the boundary, the second edge of the boundary and a second point within the boundary. The first point is closer to the first end of the boundary than to the second end of the boundary. The second point is closer to the second end of the boundary than to the first end of the boundary. The first distance is different from the second distance. The object is free from sharing a sidewall with a shape defined by a border intersecting the boundary.

Another aspect of this description is related to an apparatus, comprising at least one processor and at least one memory connected to the at least one processor and including computer program code for one or more programs. The at least one memory and the computer program code are configured to, with the at least one processor, cause the apparatus to detect a first input indicative of a first position in an image output by a display. The apparatus is also caused to detect a second input indicative of a second position in the image different from the first position. The apparatus is further caused to cause an object to be output by the display based on the first input or the second input, the object comprising a boundary having a first end closer to the first position than to the second position, and a second end closer to the second position than to the first position. The first end of the boundary is displayed having a first distance between a first edge of the boundary and a second edge of the boundary along a first axis connecting the first edge of the boundary, the second edge of the boundary and a first point within the boundary. The second end of the boundary is displayed having a second distance between the first edge of the boundary and the second edge of the boundary along a second axis parallel to the first axis connecting the first edge of the boundary, the second edge of the boundary and a second point within the boundary. The first point is closer to the first end of the boundary than to the second end of the boundary. The second point is closer to the second end of the boundary than to the first end of the boundary. The first distance is different from the second distance. The object is free from sharing a sidewall with a shape defined by a border intersecting the boundary.

A further aspect of this description is related to a non-transitory computer-readable storage medium carrying one or more sequences of one or more instructions which, when executed by one or more processors, cause an apparatus to detect a first input indicative of a first position in an image output by a display. The apparatus is also caused to detect a second input indicative of a second position in the image different from the first position. The apparatus is further caused to cause an object to be output by the display based on the first input or the second input, the object comprising a boundary having a first end closer to the first position than to the second position, and a second end closer to the second position than to the first position. The first end of the boundary is displayed having a first distance between a first edge of the boundary and a second edge of the boundary along a first axis connecting the first edge of the boundary, the second edge of the boundary and a first point within the boundary. The second end of the boundary is displayed having a second distance between the first edge of the boundary and the second edge of the boundary along a second axis parallel to the first axis connecting the first edge of the boundary, the second edge of the boundary and a second point within the boundary. The first point is closer to the first end of the boundary than to the second end of the boundary. The second point is closer to the second end of the boundary than to the first end of the boundary. The first distance is different from the second distance. The object is free from sharing a sidewall with a shape defined by a border intersecting the boundary.

The above-mentioned embodiments are merely an example for facilitating an understanding of the present disclosure, and does not serve to limit an interpretation of the present disclosure. It is to be understood that the present disclosure can be changed and modified without departing from the gist of the disclosure, and that the present disclosure includes equivalents thereof.

1. A method, comprising:
detecting a first input indicative of a first position in an image output by a display;
detecting a second input indicative of a second position in the image different from the first position; and
causing an object to be output by the display based on the first input or the second input, the object comprising a boundary having a first end closer to the first position than to the second position, and a second end closer to the second position than to the first position,
wherein
the first end of the boundary is displayed having a first distance between a first edge of the boundary and a second edge of the boundary along a first axis connecting the first edge of the boundary, the second edge of the boundary and a first point within the boundary,
the second end of the boundary is displayed having a second distance between the first edge of the boundary and the second edge of the boundary along a second axis parallel to the first axis connecting the first edge of the boundary, the second edge of the boundary and a second point within the boundary,
the first point is closer to the first end of the boundary than to the second end of the boundary,
the second point is closer to the second end of the boundary than to the first end of the boundary,
the first distance is different from the second distance, and
the object is free from sharing a sidewall with a shape defined by a border intersecting the boundary.

2. The method of claim 1, wherein the object is caused to be displayed in a location that is (1) one or more of at the first position, proximate to the first position, or surrounding the first position, and (2) one or more of at the second position, proximate to the second position, or surrounding the second position.

3. The method of claim 1, wherein one or more of the image or the object is caused to be displayed as being two-dimensional.

4. The method of claim 1, wherein one or more of the image or the object is caused to be displayed as being three-dimensional.

5. The method of claim 1, wherein the image is caused to be displayed having an appearance of being stationary.

6. The method of claim 1, wherein the image is caused to be displayed having an appearance of being in motion.

7. The method of claim 1, wherein the second input is indicative of a movement from the first position to the second position, and the object is caused to be displayed based on the movement.

8. The method of claim 1, wherein the object is a final object, and the method further comprises:
causing an initial object to be displayed based on the first input, the initial object being defined by a boundary having an initial shape; and
stretching the initial object to generate the final object by deforming the boundary of the initial object and changing the initial shape of the initial object to a final shape different from the initial shape based on the second input.

9. The method of claim 8, wherein the initial object is caused to be displayed surrounding the first position.

10. The method of claim 8, wherein the initial shape is caused to be displayed having a circular shape.

11. The method of claim 8, wherein the final object is a first final object, and the method further comprises:
causing one or more other objects to be displayed based on the first input or on the second input, the one or more other objects each having a corresponding boundary, the corresponding boundary of each of the one or more other objects having a corresponding initial shape; and
stretching at least one of the one or more other objects to generate at least one corresponding second final object by deforming the boundary of the at least one other object and changing the initial shape of the at least one other object to a different shape based on the second input or on a third input corresponding to a third position in the image.

12. The method of claim 1, wherein the object is a final object, and the method further comprises:
causing an initial object to be displayed based on the first input, the initial object being defined by a boundary having an initial shape;
dividing the initial object into a first portion and a second portion;
displacing at least the second portion from an initial position associated with the initial object to a final position associated with the final object based on the second input; and
stretching one or more sidewalls of the first portion or the second portion to connect with one or more sidewalls of the other of the first portion or the second portion to generate the final object.

13. The method of claim 12, wherein dividing the initial object comprises dividing the initial object into at least two equal-sized portions.

14. The method of claim 12, further comprising:
enlarging one of the first portion or the second portion to be enlarged based on a distance the second portion is displaced from the initial position.

15. The method of claim 1, wherein the object is a final object having a final orientation with respect to the first axis, and the method further comprises:
causing an initial object to be displayed based on the first input, the initial object being defined by a boundary having an initial orientation with respect to the first axis different from the final orientation; and
rotating at least a portion of the initial object from the first orientation to the final orientation based on the second input to generate the final object.

16. The method of claim 1, wherein the first input and the second input are detected based on a contact with the display.

17. The method of claim 16, wherein the first input is a point at which the contact is made with the display and the second input is based on a determination that the contact is ended or a movement of the contact from the first position to the second position is ended.

18. The method of claim 1, wherein the boundary of the object is caused to be displayed having an entirely curved sidewall.

19. An apparatus, comprising:
at least one processor; and
at least one memory connected to the at least one processor and including computer program code for one or more programs, the at least one memory and the computer program code are configured to, with the at least one processor, cause the apparatus to:
detect a first input indicative of a first position in an image output by a display;
detect a second input indicative of a second position in the image different from the first position; and
cause an object to be output by the display based on the first input or the second input, the object comprising a boundary having a first end closer to the first position than to the second position, and a second end closer to the second position than to the first position,
wherein
the first end of the boundary is displayed having a first distance between a first edge of the boundary and a second edge of the boundary along a first axis connecting the first edge of the boundary, the second edge of the boundary and a first point within the boundary,
the second end of the boundary is displayed having a second distance between the first edge of the boundary and the second edge of the boundary along a second axis parallel to the first axis connecting the first edge of the boundary, the second edge of the boundary and a second point within the boundary,
the first point is closer to the first end of the boundary than to the second end of the boundary,
the second point is closer to the second end of the boundary than to the first end of the boundary,
the first distance is different from the second distance, and
the object is free from sharing a sidewall with a shape defined by a border intersecting the boundary.

20. A non-transitory computer-readable storage medium carrying one or more sequences of one or more instructions which, when executed by one or more processors, cause an apparatus to:
detect a first input indicative of a first position in an image output by a display;
detect a second input indicative of a second position in the image different from the first position; and
cause an object to be output by the display based on the first input or the second input, the object comprising a boundary having a first end closer to the first position than to the second position, and a second end closer to the second position than to the first position,
wherein
the first end of the boundary is displayed having a first distance between a first edge of the boundary and a second edge of the boundary along a first axis connecting the first edge of the boundary, the second edge of the boundary and a first point within the boundary,
the second end of the boundary is displayed having a second distance between the first edge of the boundary and the second edge of the boundary along a second axis parallel to the first axis connecting the first edge of the boundary, the second edge of the boundary and a second point within the boundary,
the first point is closer to the first end of the boundary than to the second end of the boundary,
the second point is closer to the second end of the boundary than to the first end of the boundary,
the first distance is different from the second distance, and
the object is free from sharing a sidewall with a shape defined by a border intersecting the boundary.
